(19) United States
(12) Patent Application Publication
(10) Pub. No.: US 2014/0055510 A1
(43) Pub. Date: Feb. 27, 2014

(54) DISPLAY APPARATUS AND CONTROL METHOD THEREOF

(71) Applicant: CANON KABUSHIKI KAISHA, Tokyo (JP)

(72) Inventor: Kazuya Kitada, Sagamihara-shi (JP)

(73) Assignee: CANON KABUSHIKI KAISHA, Tokyo (JP)

(21) Appl. No.: 13/970,767

(22) Filed: Aug. 20, 2013

(30) Foreign Application Priority Data
Aug. 23, 2012 (JP) 2012-184149
Jun. 14, 2013 (JP) 2013-125487

(51) Int. Cl. G09G 5/10

(52) U.S. Cl. CPC G09G 5/10
USPC 345/694

(57) ABSTRACT

A display apparatus according to the present invention includes: a light-emitting unit of which emission brightness is controllable for each divided region of a screen; a display panel which displays an image on the screen by transmitting light from the light-emitting unit at a transmittance in accordance with an image signal; and a control unit which controls the emission brightness of the light-emitting unit for each divided region, wherein the control unit controls emission brightness for a mixed divided region based on an image signal of the mixed divided region, and controls emission brightness for a monochromatic divided region based on a representative value of emission brightness of a plurality of the mixed divided regions.

### BACKGROUND OF THE INVENTION

1. Field of the Invention

The present invention relates to a display apparatus and a control method thereof.

2. Description of the Related Art

Conventionally, there is a display apparatus in which a backlight including a plurality of light-emitting units (backlight light source units) arranged in a matrix pattern is provided on a rear side of a display panel. The light-emitting unit includes one or more light-emitting elements. For example, a fluorescent lamp (such as a cold cathode fluorescent tube), an LED (light-emitting diode), and the like can be used as the light-emitting element. Emission brightness of each light-emitting element can be controlled by a value of an applied current or voltage.

As disclosed in Japanese Patent Application Laid-open No. 2007-183608, in the display apparatus described above, emission brightness of a backlight can be controlled for each divided region that is obtained by dividing a screen. Specifically, a plurality of divided regions obtained by dividing the screen respectively correspond to the plurality of light-emitting units and each of the plurality of light-emitting units can be individually controlled. Such control is referred to as local dimming control. When a gradation value (brightness) of an image to be displayed is locally high or low, contrast can be enhanced by performing local dimming control. For example, contrast can be enhanced by reducing emission brightness of the backlight in a region of a dark image or increasing the emission brightness of the backlight in a region of a bright image.

In addition, due to a difference in size between an input image and the screen (for example, a difference in aspect ratios), a region where the input image is not displayed (a non-display region) may exist in the screen. For example, a non-display region may exist above or below, or to the left or right, of a region in which the input image is displayed. In such a case, a monochromatic (for example, black) still image may be added to the input image to display the input image to which the monochromatic still image has been added so that the non-display region becomes a monochromatic still image region.

Examples of conventional art related to a method of controlling the emission brightness of a backlight when displaying an image including a black still image region include a technique which increases visibility of an image by reducing the emission brightness of the backlight of a divided region corresponding to a black still image region (Japanese Patent Application Laid-open No. 2004-212503).

However, with the conventional art described above, image quality deteriorates when there is a divided region in which both a monochromatic still image region and a region other than a monochromatic still image region are displayed (a mixed region).

For example, when a monochromatic still image region is a black still image region and a mixed region corresponds to a black still image region, a brightness level difference due to a difference in backlight emission brightness is created between divided regions in which regions other than the black still image region are displayed. Specifically, an unacceptably dark black level is created in a mixed region (a region other than the black still image region becomes darker than other divided regions in a mixed region). Even when controlling the emission brightness of the mixed region based on an image signal (brightness) of a monochromatic still image region, a brightness level difference is created in a similar manner between divided regions in which regions other than the monochromatic still image region is displayed.

In addition, when a monochromatic still image region is a black still image region and a mixed region does not correspond to the black still image region, a brightness level difference due to a difference in backlight emission brightness is created between divided regions in which the black still image region is displayed. Specifically, an unacceptably bright black level is created in a mixed region (the black still image region becomes brighter than other divided regions in a mixed region). Even when controlling the emission brightness of the mixed region based on an image signal (brightness) of a region other than a monochromatic still image region, a brightness level difference is created in a similar manner between divided regions in which the monochromatic still image region is displayed.

Furthermore, when controlling the emission brightness of a mixed region based on an image signal without distinguishing between a monochromatic still image region and regions other than the monochromatic still image region, both of the brightness level differences described above are created.

### SUMMARY OF THE INVENTION

The present invention provides a technique capable of controlling emission brightness of a backlight for each divided region to enhance contrast and suppressing deterioration of image quality when a divided region exists which includes a monochromatic still image region and a region other than a monochromatic still image region.

The present invention in its first aspect provides a display apparatus comprising:

a light-emitting unit of which emission brightness is controllable for each divided region of a screen;

a display panel which displays an image on the screen by transmitting light from the light-emitting unit at a transmittance in accordance with an image signal; and

a control unit which controls the emission brightness of the light-emitting unit for each divided region, wherein

when there exist a monochromatic divided region that is a divided region in which only a monochromatic image is displayed and a mixed divided region that is a divided region in which a monochromatic image and an image other than a monochromatic image are displayed,

the control unit

controls emission brightness for the mixed divided region based on an image signal of the mixed divided region, and

controls emission brightness for the monochromatic divided region based on a representative value of emission brightness of a plurality of the mixed divided regions.

The present invention in its second aspect provides a control method of a display apparatus, this display apparatus including

a light-emitting unit of which emission brightness is controllable for each divided region of a screen, and

a display panel which displays an image on the screen by transmitting light from the light-emitting unit at a transmittance in accordance with an image signal, the method comprising

a control step of controlling the emission brightness of the light-emitting unit for each divided region, wherein

when there exist a monochromatic divided region that is a divided region in which only a monochromatic image is displayed and a mixed divided region that is a divided region in which a monochromatic image and an image other than a monochromatic image are displayed,

the control step includes:

a first step of controlling emission brightness for the mixed divided region based on an image signal of the mixed divided region; and

a second step of controlling emission brightness for the monochromatic divided region based on a representative value of emission brightness of a plurality of the mixed divided regions.

According to the present invention, the emission brightness of a backlight can be controlled for each divided region to enhance contrast and deterioration of image quality can be suppressed when a divided region exists which includes a monochromatic still image region and a region other than a monochromatic still image region.

Further features of the present invention will become apparent from the following description of exemplary embodiments with reference to the attached drawings.

### BRIEF DESCRIPTION OF THE DRAWINGS

FIG. 1 is a block diagram showing an example of a functional configuration of a display apparatus according to a first embodiment;

FIGS. 2A and 2B are schematic views showing examples of a display unit and a light-emitting unit;

FIG. 3 is a flowchart showing an example of processing by the display apparatus according to the first embodiment;

FIGS. 4A and 4B are schematic views showing examples of input/output images of a black still image adding unit according to the first embodiment;

FIGS. 5A to 5D are schematic views showing examples of emission brightness of each divided region according to the first embodiment;

FIGS. 6A and 6B are schematic views showing examples of an effect of image processing according to the first embodiment;

FIGS. 7A and 7B are schematic views showing examples of emission brightness of each divided region according to a second embodiment;

FIG. 8 is a flow chart showing an example of processing by a display apparatus according to a third embodiment; and

FIGS. 9A and 9B are schematic views showing examples of emission brightness of each divided region according to a fourth embodiment.

### DESCRIPTION OF THE EMBODIMENTS

Hereinafter, a display apparatus and a control method thereof according to embodiments of the present invention will be described with reference to the drawings. However, it should be noted that the following embodiments are simply examples and the present invention is not limited thereto.

### First Embodiment

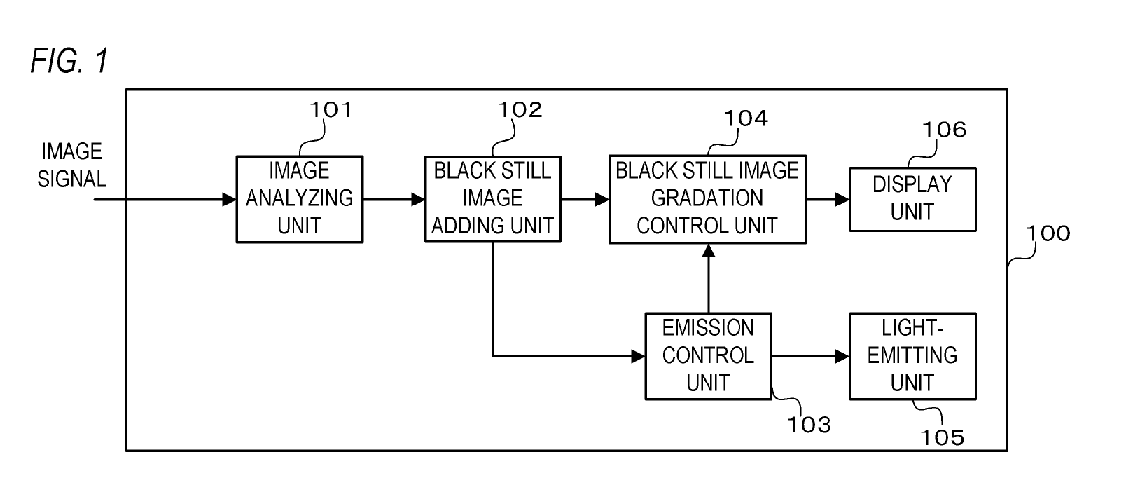

FIG. 1 is a block diagram showing an example of a functional configuration of a display apparatus 100 according to a first embodiment. The display apparatus 100 displays images based on input image signals.

A light-emitting unit 105 is a backlight of which emission brightness is controllable for each divided region that is obtained by dividing a screen.

The display unit 106 is a display panel which displays an image on the screen by transmitting light from the light-emitting unit 105 at transmittance in accordance with an image signal. In the present embodiment, the display unit 106 transmits light from the light-emitting unit 105 at transmittance in accordance with an image signal outputted from a black still image gradation control unit 104 (to be described later). For example, a liquid crystal panel can be used as the display unit 106. However, the display unit 106 is not limited to a liquid crystal panel.

An image analyzing unit 101 determines whether an input image signal is an image signal to be displayed on an entire screen or an image signal to be displayed in part of the screen. In the present embodiment, the image analyzing unit 101 compares an aspect ratio of an input image signal and an aspect ratio of the screen to determine whether the input image signal is an image signal to be displayed on the entire screen or an image signal to be displayed in part of the screen. When the input image signal is an image signal to be displayed in part of the screen, a no-signal region exists above or below, to the left or right, or around a region in which the input image signal is displayed among regions of the screen. A no-signal region is a region in which the input image signal is not displayed. The image analyzing unit 101 sends no-signal region information representing a no-signal region as a determination result to a black still image adding unit 102.

Moreover, a method of determining whether an input image signal is an image signal to be displayed on the entire screen or an image signal to be displayed in part of the screen is not limited to the method described above. For example, whether an input image signal is an image signal to be displayed on the entire screen or an image signal to be displayed in part of the screen may be determined by comparing an image size of the input image signal with a size of the screen.

When the image analyzing unit 101 determines that an input image signal is an image signal to be displayed in part of the screen, the black still image adding unit 102 generates an image signal to be displayed on the entire screen by adding an image signal of a monochromatic still image region to the input image signal. In the present embodiment, the monochromatic still image region is assumed to be a black still image region.

Specifically, based on the no-signal region information outputted from the image analyzing unit 101, the black still image adding unit 102 adds an image signal of a black still image region to the input image signal so that the no-signal region becomes a black still image region.

The black still image adding unit 102 outputs the input image signal to which an image signal of a black still image region has been added as a display image signal to an emission control unit 103 and the black still image gradation control unit 104. When the image analyzing unit 101 determines that the input image signal is an image signal to be displayed on the entire screen, the black still image adding unit 102 outputs the input image signal to the emission control unit 103 and the black still image gradation control unit 104 as a display image signal without adding an image signal of a black still image region. In addition, the black still image adding unit 102 outputs black still image region information to the emission control unit 103 and the black still image gradation control unit 104.

The emission control unit 103 controls emission brightness of the light-emitting unit 105 of each divided region based on the display image signal and the black still image region information outputted from the black still image adding unit 102. The emission control unit 103 outputs emission brightness information representing the emission brightness of the light-emitting unit 105 of each divided region (emission brightness after control; emission brightness determined based on the display image signal and the black still image region information) to the black still image gradation control unit 104.

Based on the emission brightness of the light-emitting unit 105 of each divided region determined by the emission control unit 103, the black still image gradation control unit 104 performs image processing on the display image signal outputted from the black still image adding unit 102. Specifically, based on the black still image region information outputted from the black still image adding unit 102 and the emission brightness information outputted from the emission control unit 103, the black still image gradation control unit 104 corrects a gradation value of a signal of the black still image region in the display image signal so that on-screen brightness of the black still image region becomes uniform. The black still image gradation control unit 104 sends the display image signal after image processing to the display unit 106.

Moreover, image processing other than processing for correcting a gradation value of a signal of a black still image region may be performed on the display image signal. For example, for each divided region, a gradation value of a signal of a region other than a black still image region may be corrected so that on-screen brightness of a brightest portion does not change.

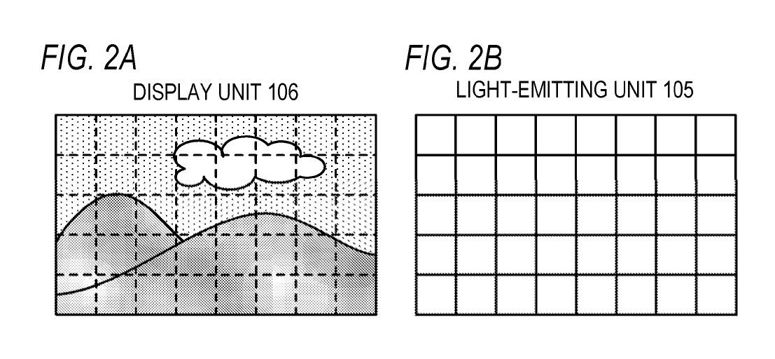

FIGS. 2A and 2B show the display unit 106 and the light-emitting unit 105.

FIG. 2A shows the display unit 106. In the example shown in FIG. 2A, while the display unit 106 (the screen) is divided into 5 rows×8 columns=40 divided regions, the display unit 106 is configured such that the display unit 106 can be independently driven per pixel which is finer than the 40 divided regions. Therefore, the 40 divided regions are virtual control regions for driving the respective pixels and the display unit 106 need not necessarily be divided as hardware.

FIG. 2B shows the light-emitting unit 105. The light-emitting unit 105 includes 40 (=5 rows×8 columns) divided light-emitting units corresponding to the 40 divided regions. In similar manner to the display unit 106, the light-emitting unit 105 may be capable of independently controlling the emission brightness of each divided region. When the divided region is constituted by an assembly of light-emitting elements finer than the divided region such as a secondary array of an LED, the divided region may be a virtual control region.

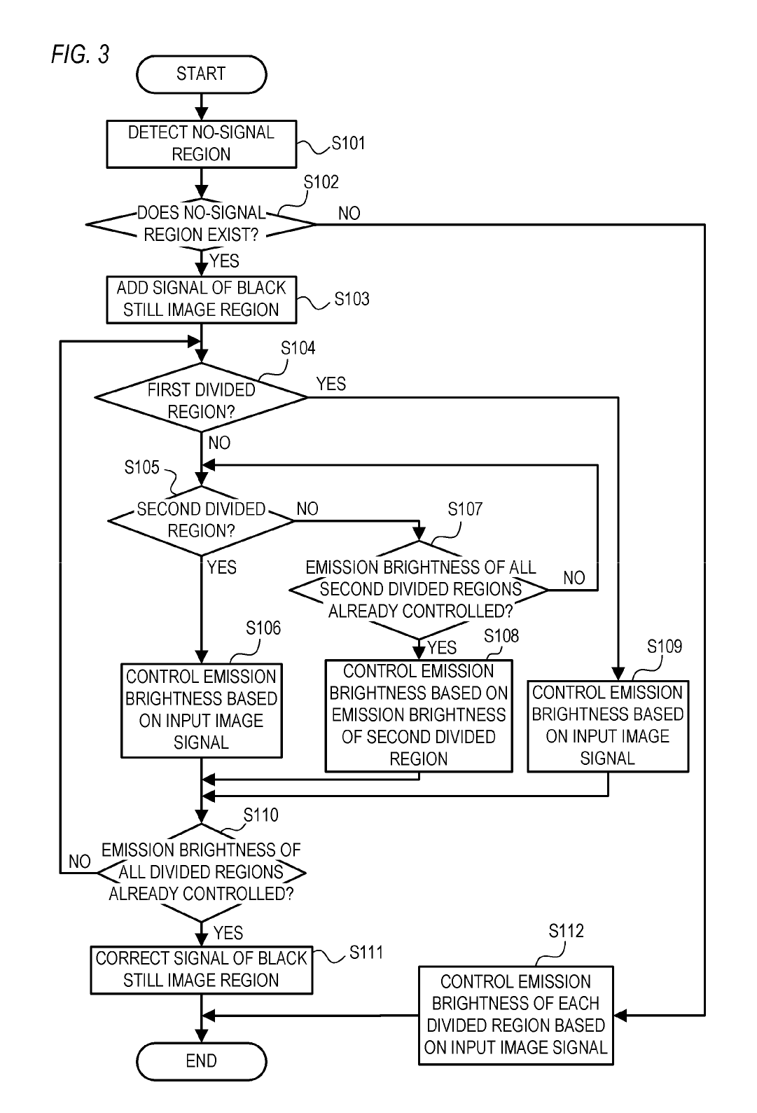

FIG. 3 shows a flow chart of processing by the display apparatus 100. In the present embodiment, the processing illustrated by the flow chart in FIG. 3 is performed each time an image signal corresponding to one frame is inputted.

First, in S101, the image analyzing unit 101 detects a no-signal region from an aspect ratio of an input image signal and an aspect ratio of the display panel.

Next, in S102, the black still image adding unit 102 determines whether or not a no-signal region exists based on no-signal region information outputted from the image analyzing unit 101.

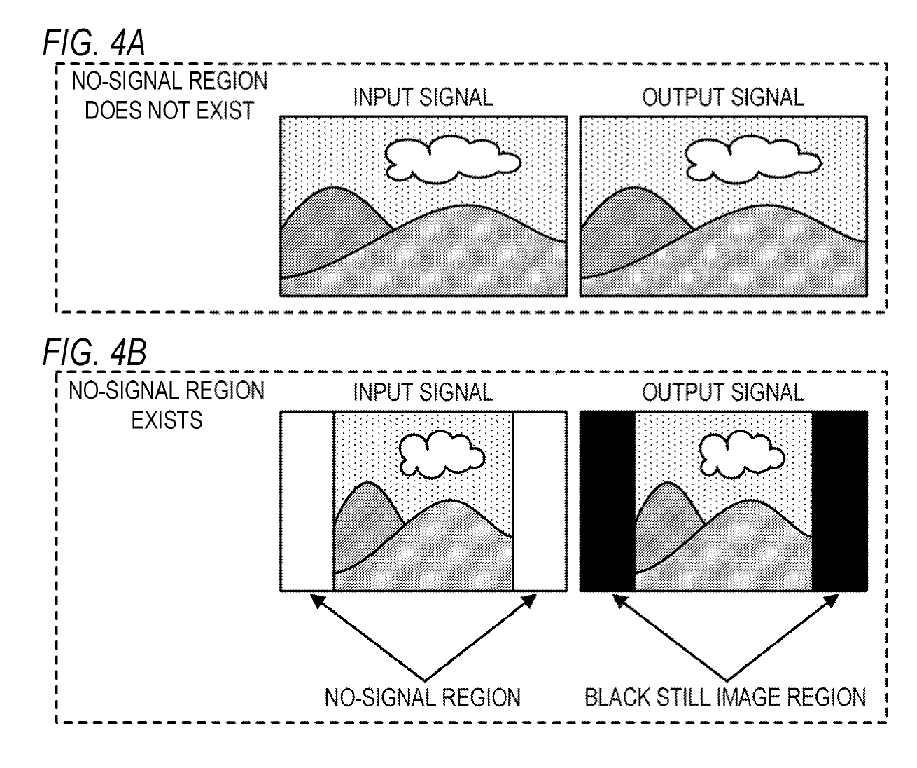

When it is determined in S102 that a no-signal region does not exist, the black still image adding unit 102 outputs the input image signal without modification as shown in FIG. 4A. Subsequently, processing jumps to S112. The input image signal is inputted to the display unit 106.

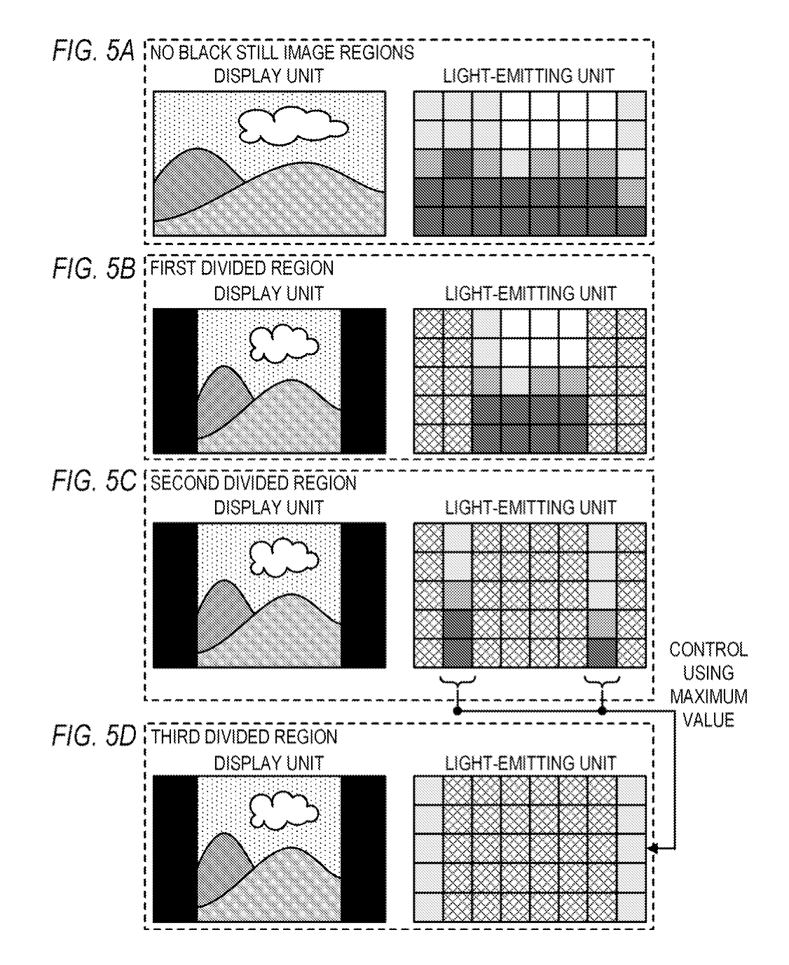

In S112, as shown in FIG. 5A, the emission control unit 103 individually controls emission brightness of each divided light-emitting unit (emission brightness of the light-emitting unit 105 of each divided region) based on the input image signal. For example, for each divided region, emission brightness of a divided light-emitting unit corresponding to the divided region is determined (set) based on a maximum value (a maximum value of pixel values or brightness values) of an image signal displayed in the divided region.

Moreover, a method of controlling the emission brightness of a divided light-emitting unit is not limited to the method described above. The emission brightness may alternatively be determined based on a minimum value, a mode value, a median value, an average value, or the like of an image signal. The emission brightness of a single divided light-emitting unit may be determined based on an image signal displayed in a corresponding divided region and divided regions around the corresponding divided region. The emission brightness of a single divided light-emitting unit may be determined based on an entire image signal. As described above, a method of controlling the emission brightness of each divided light-emitting unit is not particularly limited. This also applies to a method of controlling emission brightness which will be described with reference to subsequent processing.

Moreover, in FIGS. 5A to 5D, respective divided light-emitting units are depicted such that the higher the emission brightness, the closer the color thereof to white. In other words, the respective divided light-emitting units are depicted such that the lower the emission brightness, the closer the color thereof to black. In addition, divided light-emitting units other than the described divided light-emitting units are shown shaded.

When it is determined that a no-signal region exists in S102, processing proceeds to S103.

In S103, as shown in FIG. 4B, the black still image adding unit 102 adds an image signal of a black still image region to the input image signal so that the no-signal region becomes a black still image region. In addition, the black still image adding unit 102 outputs the input image signal to which a black still image region has been added as a display image signal.

Moreover, while black still image regions are depicted to the left and the right of a region of the input image signal in the example shown in FIG. 4B, positions of a black still image region are not limited to this example. Depending on the size of the input image signal, regions above and below the region of the input image signal may become black still image regions or a region around the region of the input image signal may become a black still image region.

Subsequently, in S104 to S110, emission brightness of divided light-emitting units is sequentially and individually controlled. Alternatively, the emission brightness of the respective divided light-emitting units may be controlled in parallel.

In S104, based on the black still image region information, the emission control unit 103 determines whether or not a black still image region is to be displayed in a divided region that is a processing object (a divided region corresponding to a divided light-emitting unit that is a processing object). In other words, a determination is made regarding whether or not a divided region that is a processing object is a first divided region in which only a region other than a black still image region (a region other than a monochromatic still image region) is displayed.

When the divided region that is a processing object is determined to be a first divided region in S104, processing jumps to S109.

In S109, as shown in FIG. 5B, the emission control unit 103 controls emission brightness of the divided region that is a processing object (the first divided region) based on an image signal of a region other than a black still image region in the display image signal. Subsequently, processing proceeds to S110.

In S109, emission brightness may be determined based on a signal of a region other than a black still image region which is displayed in the divided region that is a processing object. The emission brightness may be determined based on a signal of a region other than a black still image region which is displayed in the divided region that is a processing object and in surrounding divided regions. The emission brightness may be determined based on an entire signal of a region other than a black still image region.

When the divided region that is a processing object is determined not to be a first divided region in S104, processing proceeds to S105.

In S105, based on the black still image region information, the emission control unit 103 determines whether or not a region other than a black still image region is to be displayed in the divided region that is a processing object. In other words, a determination is made regarding whether or not the divided region that is a processing object is a second divided region in which a black still image region (a monochromatic image) and a region other than a black still image region (an image other than a monochromatic image) are displayed (mixed) or a third divided region in which only a black still image region is displayed.

When the divided region that is a processing object is determined to be a second divided region in S105, processing proceeds to S106.

In S106, as shown in FIG. 5C, the emission control unit 103 controls emission brightness of the divided region that is a processing object (the second divided region) based on a signal of a region other than a black still image region in the display image signal. Subsequently, processing jumps to S110.

As described above, according to the present embodiment, the emission brightness of divided regions in which regions other than a black still image region are displayed (the first divided region and the second divided region) is determined based on a signal of a region other than a black still image region in the display image signal. Accordingly, an effect of a black still image region on on-screen brightness of regions other than a black still image region can be eliminated. As a result, contrast of regions other than a black still image region can be enhanced and deterioration of image quality in regions other than a black still image region can be suppressed. Specifically, the occurrence of brightness level differences in regions other than a black still image region (the occurrence of an unacceptably dark black level in the second divided region) can be suppressed.

When the divided region that is a processing object is determined to be a third divided region in S105, processing jumps to S107.

In S107, the emission control unit 103 determines whether or not emission brightness of all second divided regions has been controlled.

When it is determined in S107 that there is a second divided region whose emission brightness has not been controlled, the emission control unit 103 sets the second divided region whose emission brightness has not been controlled as a divided region that is a processing object and processing is returned to S105. Alternatively, processing may proceed to S106 instead of returning to S105.

When it is determined in S107 that the emission brightness of all second divided regions has been controlled, processing proceeds to S108.

In S108, the emission control unit 103 controls the emission brightness of the divided region that is a processing object (the third divided region) so that a difference from the emission brightness of the second divided region (the emission brightness determined in S106) is reduced. In the present embodiment, as shown in FIGS. 5C and 5D, the emission brightness of the divided region that is a processing object is controlled to emission brightness equal to a maximum value (a representative value) of emission brightness of a plurality of second divided regions. Subsequently, processing jumps to S110.

As described above, according to the present embodiment, when a first divided region, a second divided region, and a third divided region exist, emission brightness of the third divided region is controlled so that a difference from the emission brightness of the second divided region is reduced. Accordingly, deterioration of image quality of a black still image region can be suppressed. Specifically, an unacceptably bright black level in the second divided region can be reduced.

Moreover, when the second divided region does not exist, a value based on a display image signal or a predetermined value may be set as the emission brightness of the third divided region.

In S110, the emission control unit 103 determines whether or not emission brightness of all divided regions has been controlled.

When it is determined in S110 that there is a divided region whose emission brightness has not been controlled, the emission control unit 103 sets the divided region whose emission brightness has not been controlled as a divided region that is a processing object and processing is returned to S104.

When it is determined in S110 that the emission brightness of all divided regions has been controlled, processing proceeds to S111.

In S111, based on emission brightness of each divided region, the black still image gradation control unit 104 corrects a gradation value of a signal of a black still image region in a display image signal so that on-screen brightness of the black still image region becomes uniform. Subsequently, the black still image gradation control unit 104 outputs the corrected display image signal to the display unit 106.

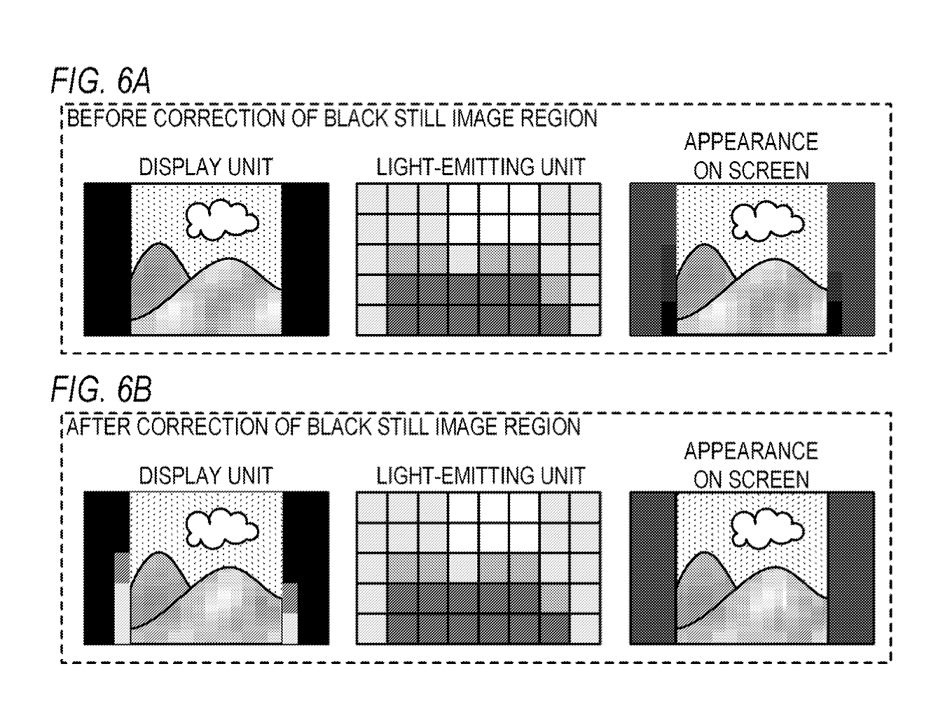

In the present embodiment, the emission brightness of divided regions in which a black still image region is displayed (the second divided region and the third divided region) does not always become uniform. Therefore, when the gradation value of the black still image region is not corrected, as shown in FIG. 6A, uneven brightness may sometimes occur in a black still image region due to a difference in emission brightness. In consideration thereof, in the present embodiment, as shown in FIG. 6B, the on-screen brightness of a black still image region is made uniform by correcting a gradation value of the black still image region based on the emission brightness of a divided region in which the black still image region is displayed. For example, based on a maximum value of the emission brightness of a divided region in which the black still image region is displayed, for each divided region, a gradation value of a black still image region displayed in the divided region is corrected by a correction value in accordance with a difference between the emission brightness of the divided region and reference emission brightness. Accordingly, even if emission brightness differs between divided regions, the on-screen brightness of a black still image region can be made uniform and deterioration of image quality of the black still image region (an occurrence of uneven brightness) can be suppressed.

Moreover, when a plurality of third divided regions (monochromatic divided regions) exist, the gradation values of image signals of monochromatic divided regions are favorably corrected so that on-screen brightness of the monochromatic divided regions becomes equal to one another. For example, when a plurality of black still image regions (monochromatic still image regions) exist, the gradation values of signals of black still image regions are favorably corrected so that on-screen brightness of the black still image regions (monochromatic still image regions) becomes equal to one another. Such a correction can be realized by, for example, setting one emission brightness reference value for all black still image regions instead of setting an emission brightness reference value for each black still image region.

Moreover, a method of correcting a gradation value of a black still image region is not limited to the method described above. For example, an emission brightness reference value may be determined in advance.

As described above, according to the present embodiment, emission brightness of a backlight can be controlled for each divided region to enhance contrast and deterioration of image quality can be suppressed when a divided region exists which includes a monochromatic still image region and a region other than a monochromatic still image region. Specifically, when a first divided region, a second divided region, and a third divided region exist, emission brightness is controlled for the first divided region and the second divided region based on a signal of a region other than a black still image region in a display image signal. Accordingly, an effect of a black still image region on on-screen brightness of regions other than the black still image region can be eliminated. As a result, contrast of regions other than the black still image region can be enhanced and deterioration of image quality in regions other than the black still image region can be suppressed. In addition, for the third divided region, emission brightness is controlled so that a difference from the emission brightness of the second divided region is reduced. Accordingly, deterioration of image quality of a black still image region can be suppressed.

Furthermore, according to the present embodiment, based on emission brightness of the backlight in each divided region, a gradation value of a signal of a black still image region in a display image signal is corrected so that on-screen brightness of the black still image region becomes uniform. Accordingly, deterioration of image quality of the black still image region can be further suppressed.

Moreover, while a configuration which corrects a gradation value of a signal of a black still image region is adopted in the present embodiment, such a correction need not necessarily be performed. In the present embodiment, a value close to the emission brightness of the second divided region is set as the emission brightness of the third divided region. Therefore, image quality of a black still image region can be improved compared to what is conventional even without performing the correction described above.

Moreover, while an example of a case where a monochromatic still image region is a black still image region has been described in the present embodiment, a color of a still image region is not limited to black. The color of a still image region may be a color other than black such as white, gray, green, and blue.

Moreover, while the emission brightness of the third divided region is controlled to emission brightness equal to a representative value (a maximum value) of the emission brightness of a plurality of second divided regions in the present embodiment, this configuration is not restrictive. A value close to the emission brightness of the second divided region need only be set for the third divided region. Accordingly, the image quality of a black still image region can be improved compared to what is conventional.

Moreover, in the present embodiment, while the processing shown in the flow chart in FIG. 3 is performed each time an image signal corresponding to one frame is inputted, this configuration is not restrictive. As long as no problems occur, a part of or all of the processing may be performed each time an image signal corresponding to one line or an image signal corresponding to one pixel is inputted.

Moreover, while an example where the emission brightness of divided light-emitting units is sequentially and individually controlled has been described in the present embodiment, this configuration is not restrictive. For example, emission brightness of all of or a part of the divided light-emitting units may be controlled in parallel. For example, the emission brightness of a plurality of first divided regions may be controlled in parallel.

Moreover, while a representative value to be used as the emission brightness of the third divided region has been determined based on the emission brightness of all second divided regions in the present embodiment, this configuration is not restrictive. For example, for each black still image region, a representative value to be used as the emission brightness of a third divided region in which the black still image region is displayed may be determined based on the emission brightness of a second divided region in which the black still image region is displayed. In other words, in S108, the emission brightness of a divided region that is a processing object may be controlled to emission brightness equal to a representative value of the emission brightness of a plurality of second divided regions which displays a same black still image region as that displayed in the divided region that is a processing object.

Moreover, while a configuration where a black still image region is added in a display apparatus has been adopted in the present embodiment, this configuration is not restrictive. Alternatively, an image signal to which a black still image region has been added may be inputted to the display apparatus. In this case, a black still image region may be detected from the image signal through image analysis or information indicating a black still image region may be acquired together with an image signal and the black still image region may be detected (determined) using the information.

### Second Embodiment

The second embodiment differs from the first embodiment in the method of controlling emission brightness (the emission brightness of the third divided region) in S108 in the flow chart shown in FIG. 3. In the first embodiment, in S108, the emission brightness of the divided region that is a processing object (the third divided region) is controlled to emission brightness equal to a maximum value of emission brightness of a plurality of second divided regions. In other words, in the first embodiment, a maximum value is used as a representative value of the emission brightness of the plurality of second divided regions. In the second embodiment, an average value is used as the representative value.

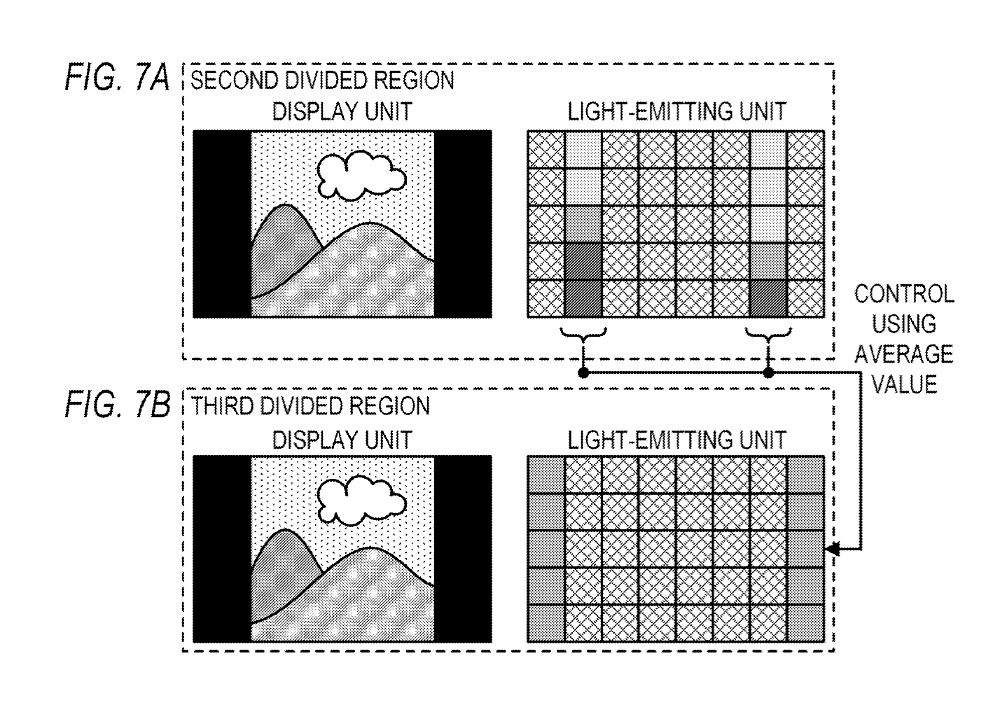

For example, let us assume that, in S106, emission brightness of each second divided region is controlled at emission brightness such as that shown in FIG. 7A. In this case, in S108, an average value (an average brightness) of the emission brightness of the second divided regions shown in FIG. 7A is calculated. In addition, emission brightness of the third divided region is controlled at the calculated average brightness as shown in FIG. 7B.

Moreover, since other configurations and processing of the display apparatus are similar to those of the first embodiment, descriptions thereof will be omitted.

As described above, according to the present embodiment, the emission brightness of the third divided region is controlled to emission brightness equal to an average value of the emission brightness of the plurality of second divided regions. Accordingly, compared to a case where a maximum value is used as a representative value, the emission brightness of the third divided region can be brought closer to the emission brightness of the plurality of second divided regions (a maximum value of a difference between the emission brightness of the third divided region and the emission brightness of the second divided regions can be reduced). Therefore, deterioration of image quality of a monochromatic still image region can be further suppressed. Moreover, the representative value is not limited to a maximum value or an average value. A minimum value, a mode value, or a median value may be adopted as the representative value.

### Third Embodiment

In the first and second embodiments, when an input image signal is an image signal of a moving image, pixel values of a second divided region may vary from frame to frame. As a result, emission brightness of the second divided region and the third divided region may vary from frame to frame and brightness of a black still image region may fluctuate. In consideration thereof, in the third embodiment, a determination is made on whether an input image signal is an image signal of a moving image or an image signal of a still image, and a black still image region and a divided light-emitting unit are controlled based on a determination result thereof. While the image analyzing unit 101 detects a no-signal region in the first embodiment, in the third embodiment, the image analyzing unit 101 further performs processing for determining whether or not an input image signal is an image signal of a still image. For example, by determining whether a pixel value of a given pixel is the same for each frame, an input image signal can be determined to be an image signal of a still image when the pixel value is the same. Moreover, the method of determining whether or not an input image signal is an image signal of a still image is not particularly limited and whether or not an input image signal is an image signal of a still image may be determined by a method that differs from that described above.

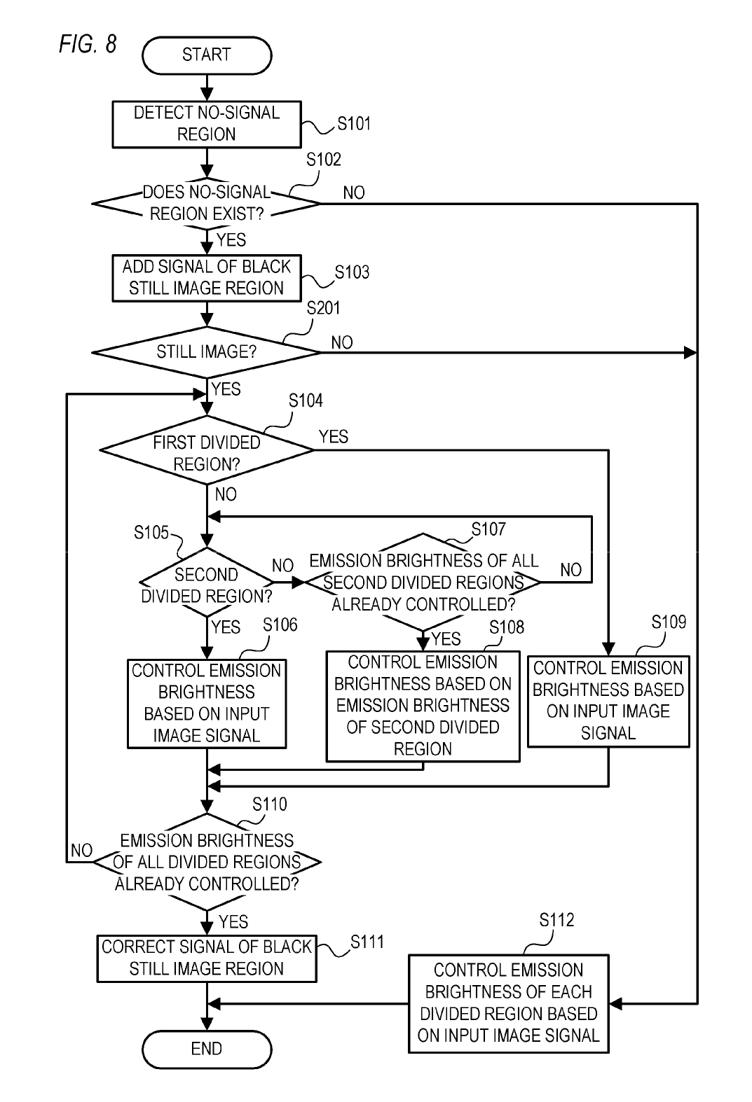

FIG. 8 shows a flow chart of processing by a display apparatus according to the present embodiment.

Processing up to S103 is similar to that of the first embodiment and a description thereof will be omitted.

Following S103, in S201, the image analyzing unit 101 determines whether or not an input image signal is a signal of a still image. When it is determined that the input image signal is a signal of a still image, processing proceeds to S104. When it is determined that the input image signal is not an image signal of a still image (the input image signal is an image signal of a moving image), processing jumps to S112.

Processing subsequent to S104 is similar to that of the first embodiment. In other words, when the input image signal is determined to be an image signal of a still image, emission brightness is controlled for a first divided region based on an image signal of the first divided region. Emission brightness is controlled for a mixed divided region (a second divided region) based on an image signal of the mixed divided region. In addition, emission brightness is controlled for a third divided region (a monochromatic divided region) based on a representative value of emission brightness of a plurality of mixed divided regions. Moreover, in S108, as the representative value, a maximum value of emission brightness (a maximum brightness) of the second divided region may be used in a similar manner to the first embodiment or an average value of emission brightness (an average brightness) of the second divided region may be used in a similar manner to the second embodiment.

In S112, the emission control unit 103 controls emission brightness of each divided region based on the input image signal. Specifically, for each divided region, the emission brightness is controlled based on an image signal of the divided region. Therefore, for a mixed divided region, the emission brightness is controlled based on an image signal of the mixed divided region, and for a monochromatic divided region, the emission brightness is controlled based on an image signal of the monochromatic divided region.

Moreover, since other configurations and processing of the display apparatus are similar to those of the first embodiment, descriptions thereof will be omitted.

As described above, according to the present embodiment, a determination is made on whether or not an input image signal is an image signal of a still image. When the input image signal is an image signal of a still image, control of a black still image region or a divided light-emitting unit is performed in a similar manner to the first and second embodiments. Accordingly, when the input image signal is an image signal of a still image, a contrast of regions other than a black still image region can be enhanced and deterioration of image quality in a black still image region or regions other than the black still image region can be suppressed. In addition, when the input image signal is not an image signal of a still image, control of a divided light-emitting unit is performed regardless of whether or not the divided light-emitting unit is in a black still image region. Accordingly, contrast of an entire screen can be enhanced. Furthermore, a variation in emission brightness between frames in the second divided region and the third divided region can be reduced and fluctuation of brightness of a black still image region can be reduced.

### Fourth Embodiment

The fourth embodiment differs from the first embodiment in the method of controlling emission brightness (the emission brightness of the third divided region) in S108 in the flow chart shown in FIG. 3. In the first embodiment, in S108, the emission brightness of a divided region that is a processing object (the third divided region) is controlled using a maximum value or an average value of emission brightness of a plurality of second divided regions. In the fourth embodiment, the image analyzing unit 101 determines whether an input image signal is an image signal of a still image or an image signal of a moving image, and the emission control unit 103 switches emission brightness of the third divided region in accordance with a determination result of the image analyzing unit 101. In the fourth embodiment, when the input image signal is determined to be an image signal of a still image, processing similar to that of the first embodiment is performed. On the other hand, when it is determined that the input image signal is not an image signal of a still image (the input image signal is an image signal of a moving image), processing that differs from that of the first embodiment is performed.

Processing when the input image signal is determined to be an image signal of a moving image will now be described.

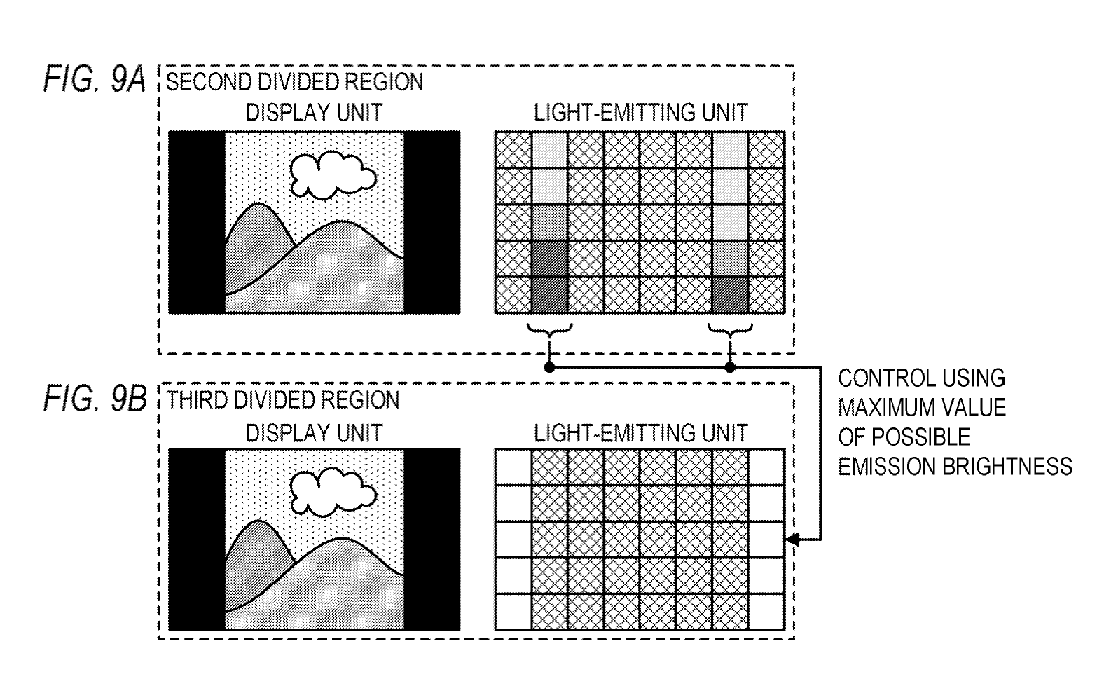

For example, let us assume that, in S106, emission brightness of each second divided region is controlled at emission brightness such as that shown in FIG. 9A. In this case, in S108, regardless of the emission brightness of the second divided region, emission brightness of the third divided region is controlled using a maximum value of possible emission brightness (a maximum brightness) as shown in FIG. 9B. By controlling emission brightness in this manner, a black still image region can be displayed at constant brightness regardless of the input image signal. However, the emission brightness of the third divided region need not necessarily be controlled using maximum brightness and may be controlled at, for example, 90% of maximum brightness or 80% of maximum brightness. Regardless of the brightness of the second divided region, an effect of the present embodiment can be obtained by controlling the brightness of the third divided region using a given predetermined fixed value.

In other words, in the present embodiment, when a monochromatic divided region and a mixed divided region exist and an input image signal is determined to be an image signal of a moving image, emission brightness is controlled to a predetermined fixed value for the monochromatic divided region. Moreover, emission brightness is controlled for a first divided region based on an image signal of the first divided region. Emission brightness is controlled for a mixed divided region (a second divided region) based on an image signal of the mixed divided region.

Moreover, since other configurations and processing of the display apparatus are similar to those of the first embodiment, descriptions thereof will be omitted.

As described above, according to the present embodiment, when an input image signal is determined to be an image signal of a moving image, the emission brightness of the third divided region is controlled using a given predetermined fixed value regardless of the emission brightness of the second divided region. Accordingly, deterioration of image quality of a black still image region can be suppressed and, at the same time, fluctuation of brightness of the black still image region between frames can be suppressed. In addition, when the input image signal is determined to be an image signal of a still image, deterioration of image quality of a black still image region can be suppressed by performing processing similar to that of the first embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-184149, filed on Aug. 23, 2012, and Japanese Patent Application No. 2013-125487, filed on Jun. 14, 2013, which are hereby incorporated by reference herein in their entirety.

What is claimed is:

1. A display apparatus comprising:
a light-emitting unit, emission brightness of the light-emitting unit being controllable for each divided region of a screen;
a display panel configured to display an image on the screen by transmitting light from the light-emitting unit at a transmittance in accordance with an image signal; and
a control unit configured to control the emission brightness of the light-emitting unit for each divided region, wherein
when there exist a monochromatic divided region that is a divided region in which only a monochromatic image is displayed and a mixed divided region that is a divided region in which a monochromatic image and an image other than a monochromatic image are displayed,
the control unit
controls emission brightness for the mixed divided region based on an image signal of the mixed divided region, and
controls emission brightness for the monochromatic divided region based on a representative value of emission brightness of a plurality of the mixed divided regions.

2. The display apparatus according to claim 1, wherein
the control unit controls the emission brightness for the monochromatic divided region to emission brightness equal to the representative value of emission brightness of a plurality of the mixed divided regions.

3. The display apparatus according to claim 1, wherein
the representative value is a maximum value, a minimum value, an average value, a median value, or a mode value of the emission brightness of the plurality of the mixed divided regions.

4. The display apparatus according to claim 1, further comprising
a correcting unit configured to correct a gradation value of an image signal of the monochromatic divided region so that on-screen brightness of the monochromatic divided region becomes uniform.

5. The display apparatus according to claim 4, wherein
when there exist a plurality of the monochromatic divided regions, the correcting unit corrects gradation values of image signals of the monochromatic divided regions so that on-screen brightness of the monochromatic divided regions is equal to one another.

6. The display apparatus according to claim 1, further comprising:
a determining unit configured to determine whether an input image signal is an image signal to be displayed on an entire screen or an image signal to be displayed in part of the screen; and
a generating unit configured to generate an image signal to be displayed on the entire screen by adding a monochromatic image signal to the input image signal when the determining unit determines that the input image signal is an image signal to be displayed in part of the screen.

7. The display apparatus according to claim 1, wherein
the monochromatic divided region that is a divided region in which only a black image is displayed.

8. A control method of a display apparatus, this display apparatus including
a light-emitting unit of which emission brightness is controllable for each divided region of a screen, and
a display panel which displays an image on the screen by transmitting light from the light-emitting unit at a transmittance in accordance with an image signal, the method comprising
a control step of controlling the emission brightness of the light-emitting unit for each divided region, wherein
when there exist a monochromatic divided region that is a divided region in which only a monochromatic image is displayed and a mixed divided region that is a divided region in which a monochromatic image and an image other than a monochromatic image are displayed,
the control step includes:
a first step of controlling emission brightness for the mixed divided region based on an image signal of the mixed divided region; and
a second step of controlling emission brightness for the monochromatic divided region based on a representative value of emission brightness of a plurality of the mixed divided regions.

9. The control method of the display apparatus according to claim 8, wherein
in the second step, the emission brightness for the monochromatic divided region is controlled to emission brightness equal to the representative value of emission brightness of a plurality of the mixed divided regions.

10. The control method of the display apparatus according to claim 8, wherein
the representative value is a maximum value, a minimum value, an average value, a median value, or a mode value of the emission brightness of the plurality of the mixed divided regions.

11. The control method of the display apparatus according to claim 8, further comprising
a correcting step of correcting a gradation value of an image signal of the monochromatic divided region so that on-screen brightness of the monochromatic divided region becomes uniform.

12. The control method of the display apparatus according to claim 11, wherein
in the correcting step, when there exist a plurality of the monochromatic divided regions, gradation values of image signals of the monochromatic divided regions are corrected so that on-screen brightness of the monochromatic divided regions is equal to one another.

13. The control method of the display apparatus according to claim 8, further comprising:
a determining step of determining whether an input image signal is an image signal to be displayed on an entire screen or an image signal to be displayed in part of the screen; and
a generating step of generating an image signal to be displayed on the entire screen by adding a monochromatic image signal to the input image signal when it is determined that the input image signal is an image signal to be displayed in part of the screen in the determining step.

14. The control method of the display apparatus according to claim 8, wherein
the monochromatic divided region that is a divided region in which only a black image is displayed.
